(19) United States
(12) Patent Application Publication
(10) Pub. No.: US 2017/0109847 A1
(43) Pub. Date: Apr. 20, 2017

(54) SYSTEM AND METHOD FOR GENERATING FUNDING FROM GOVERNMENT PROTECTED INVENTION RIGHTS

(71) Applicant: Home Producers Network, LLC, Scottsdale, AZ (US)

(72) Inventor: Craig P. Mowry, Southampton, NY (US)

(73) Assignee: Home Producers Network, LLC, Scottsdale, AZ (US)

(21) Appl. No.: 14/024,370

(22) Filed: Sep. 11, 2013

Related U.S. Application Data
(63) Continuation-in-part of application No. 12/966,826, filed on Dec. 13, 2010, now abandoned.
(60) Provisional application No. 61/286,015, filed on Dec. 13, 2009.
(60) Provisional application No. 61/324,323, filed on Apr. 15, 2010.
(60) Provisional application No. 61/349,966, filed on May 31, 2010.

(51) Int. Cl. G06Q 50/18; G06F 21/10

(52) U.S. Cl. CPC G06Q 50/184; G06F 21/105

(57) ABSTRACT

A system and method are disclosed for categorizing intellectual property and providing a solicitation to a plurality of registered members for sponsorship in the intellectual property. In response to a reply to the solicitation, materials associated with the intellectual property are provided and in response to the solicitation and/or the provided materials, a first acceptance to the sponsorship is received. Further, in response to the solicitation and/or the provided materials, a second acceptance to the sponsorship. At least one license to at least some of the classified intellectual property is provided to at least one of the registered members at a maximum threshold value.

### CROSS-REFERENCE TO RELATED APPLICATION

The present application claims priority to U.S. Provisional Patent Application No. 61/693,739, filed Aug. 27, 2012 and is a continuation-in-part of U.S. Non-Provisional patent application Ser. No. 12/966,826, filed Dec. 13, 2010, which claims priority to U.S. Provisional Patent Application No. 61/286,015, filed Dec. 13, 2009, U.S. Provisional Patent Application No. 61/324,323, filed Apr. 15, 2010, and U.S. Patent Application No. 61/349,966, filed May 31, 2010. All of the above applications are hereby incorporated by reference in their respective entireties.

### FIELD

The present application relates, generally, to intellectual property and, more particularly, to licensing thereof.

### BACKGROUND

The ability for patent owners and/or others interested in acquiring licenses for intellectual property often is difficult and seemingly unobtainable. Often, this is due to protected disclosures that are not known, are otherwise not made available to prospective licensees. Alternatively, patentees or patent applicants often do not have the financial means or personnel contacts to license or sell their intellectual property.

It would be desirable to provide a computer operable system and method for facilitating innovation.

### SUMMARY

A system and method are disclosed for categorizing intellectual property and providing a solicitation to a plurality of registered members for sponsorship in the intellectual property. In response to a reply to the solicitation, materials associated with the intellectual property are provided and in response to the solicitation and/or the provided materials, a first acceptance to the sponsorship is received. Further, in response to the solicitation and/or the provided materials, a second acceptance to the sponsorship. At least one license to at least some of the classified intellectual property is provided to at least one of the registered members at a maximum threshold value.

These and other aspects, features, and advantages of the invention can be understood with reference to the following detailed description of certain embodiments of the invention taken together in conjunction with the accompanying drawing figures.

### BRIEF DESCRIPTION OF THE DRAWINGS

FIG. 1 illustrates an example interaction related to formerly active patents of the United States Patent and Trademark Office;

FIG. 2 illustrates an example interaction between a patent applicant and both the Patent Office and/or the Department of Innovation;

FIG. 3 illustrates an example interactive relationship between the DOI and companies/entities choosing to and/or being mandated to subscribe to innovation files of the DOI library, some or all of which may include patented and/or patent-pending innovations;

FIG. 4 is a block diagram illustrating a system in accordance with an implementation of the present application; and

FIG. 5 illustrates components associated with a computing device in accordance with an implementation of the present application.

### DESCRIPTION

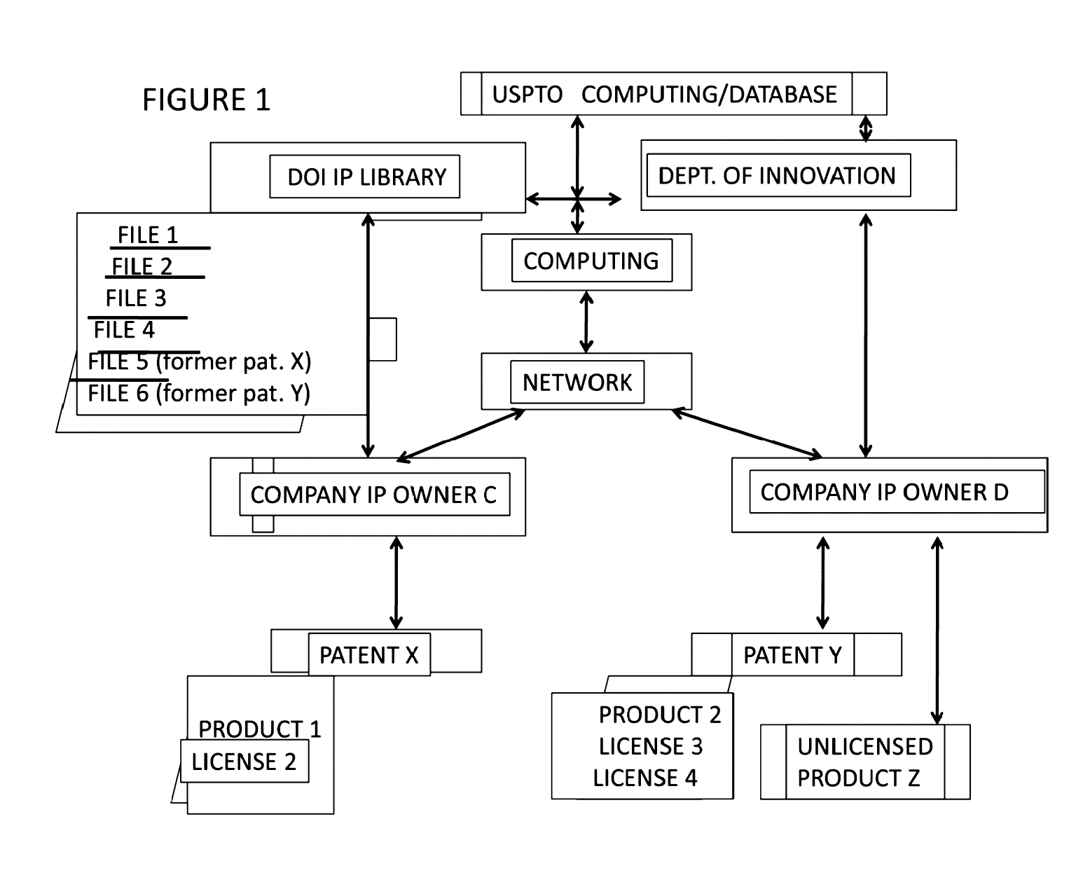

Referring to the figures, FIG. 1 illustrates an example interaction related to formerly active patents of the United States Patent and Trademark Office (“USPTO”). Here, in a scenario wherein a five-year extension term managed by a proprietor of the present application, referred to herein, generally, as the “Department of Innovation,” provides benefit to the Department and to at least two former patent owner companies.

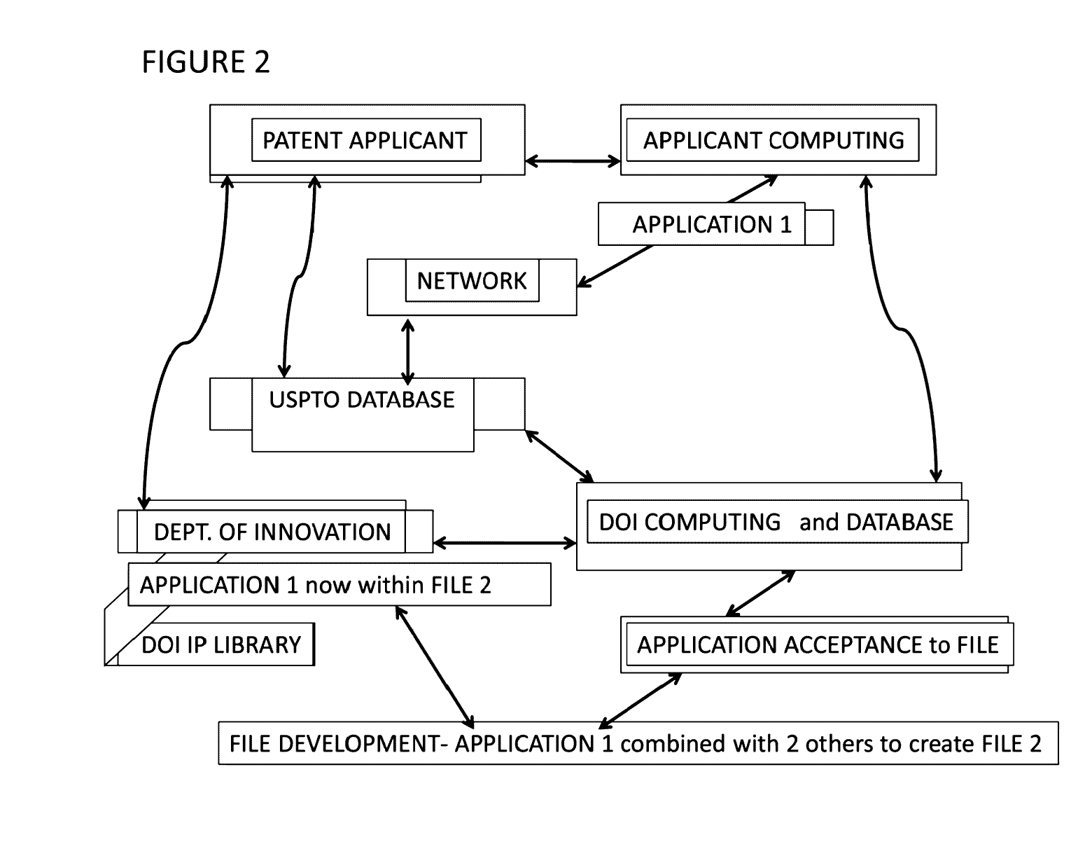

FIG. 2 illustrates an example interaction between a patent applicant and both the Patent Office and/or the Department of Innovation (“DOI”). This includes a scenario of an applicant being accepted as a material contributor/author of the DOI.

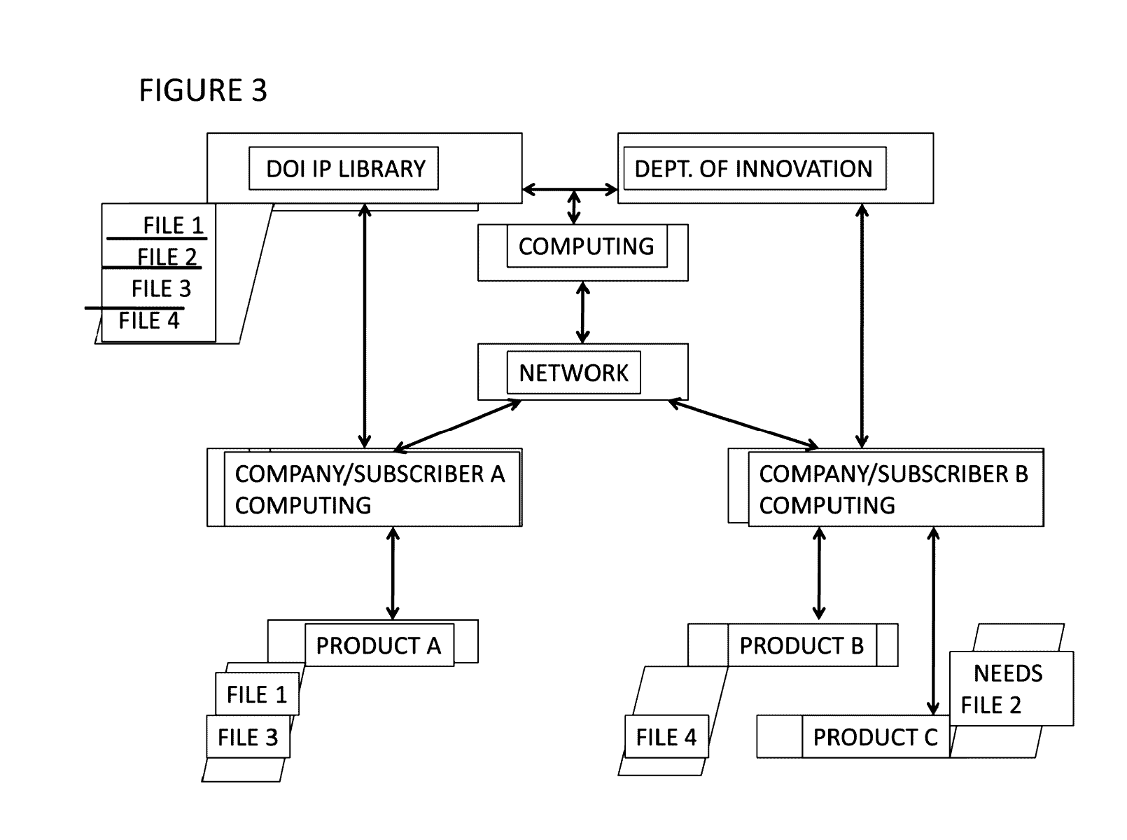

FIG. 3 illustrates an example interactive relationship between the DOI and companies/entities choosing to and/or being mandated to subscribe to innovation files of the DOI library, some or all of which may include patented and/or patent-pending innovations.

Herein, the DOI and USPTO are presented as distinct entities, however they may indeed be a single entity, or an entity with more than one aspect, such as a “departments” within a single entity, such as the USPTO. This entity may be government-based and/or a private entity, such as a company. The preferred configuration relates to at least a government department, preferably of the USA, managing the program(s) related to this system and method.

In the referred configuration a hub computer(s) manages government housed information related to inventions, inventors and patent(s) at least.

Referring to FIG. 1, the flow of information and new information pathways created by the present disclosed system/method will be explained relative to an example based on fictional patents: “X” and “Y”.

The USPTO provides the two patents in question to the DOI as at least one transmission over a network and/or by way of a database sharing scenario, where at least one database is accessible by the USPTO and the entity managing the funds generating program; herein the DOT. A prescribed period of time before they are scheduled to expire. Notifications are issued to the declared patent owners, in this example scenario, through a communications network involving computers. Notifications could also be made by mail or other communications approach.

Company(s,) such as C & D, are notified of the impending expiration dates of their intellectual property. They are provided with a time sensitive option to extend the life of their patent under a special DOI program by, in this example, five years. Both companies opt to extend the life of their patent as these patents underlie products that have been critical to company revenue; including products one, two and three.

The revenue-sharing scenario of the DOT, in this example 50% of profit revenue as defined by DOI regulations, is an entirely optional and elective program made available to these companies.

These once lucrative patents received government protection under the patent laws and allowed these companies to earn revenue from products they may directly and in this example from licenses to other companies who also used aspects of the technology in its patents.

In another configuration, replacing or augmenting scenarios based on the just disclosed scenario. The normal regulations (and exceptions to the protected patent life) are involved in creating a logical rights extension scenario for sharing funds with the DOT, in this configuration. For example, two dates key to patent life are managed in a new way to create the revenue sharing opportunity through extended rights protections: The 20 years from filing date and 17 years from issuing, factors.

Many patent applications take many years to prosecute toward allowed patent(s). Typically, in such cases, the twenty years from filing date is the nearest expiration date, with relatively adjustments to that date based on USPTO extension rules. In this configuration, the 17 years from issuing date would be the active date, (with or within any additional extensions by the USPTO due to prosecution delays and/or other issues). Based on the patent owner agreeing to share revenue from products and/or licensing of related to the extended IP rights, the patent(s) become owned and/or under the jurisdiction of the DOI, for example, at the twenty years from filing date, (without or without factoring ancillary extensions that may have been provided by the USPTO).

For the period of time, between the “normal” patent extension date and the 17 years from issue date, the DOI would collect a fixed or otherwise determined portion of earnings from patent owners and/or others utilizing the protected IP. Further, a logical adjustment from existing “factors” that would be potentially also agreeable and provide even more earning potential from innovation protections would be a “20 years from issuing” figure. In either case, without a separate, arbitrary stretch of years to extend under the DOI innovation/program, the patent life under DOI extension would be a simple alteration of the managing of the existing factors, harnessing the revenue of products/services/licenses sold during the natural spread of years between existing USPTO familiar expiration dates. For example, instead of the “whichever date comes earliest” criteria for expiration, the alteration herein would be, for example, “with an option to extend rights under the DOI program, revising expiration to whichever date occurs latest.”

In a preferred example, the patents become protected intellectual property owned by the DOI, herein file five and file six of the DOT. In this example as well the program is entirely interactive involving computing of the companies interacting through a network with computing of the DOI in all aspects of applying for, managing the details of and paying the agreed and declared revenue portions to the DOI for the benefits of their exclusive intellectual property protection extension term.

In this example scenario each company is responsible for collecting the appropriate revenue portions from every known licensee and unlicensed user, beyond what payments may be due from their own internal benefit from the products related to the patents. Should profits be misreported, or unreported, or other agreements violated related to the extension term, an obvious reprimand available to Department of innovation is a rescinding of the actual property protections.

In this scenario, Company C, who is a drug-maker, earned net revenue of $300 million per year in recent years off product one; which relies directly on technology disclosed in patent X. As this drug is anticipated to only increase in popularity during the extension term, is anticipated that the DOI will receive reporting and funds from Company C of not less than 1½ billion dollars during the five-year extension term. Naturally, DOI sharing might be related to gross and/or net earnings, of other DOI determined revenue and/or benefits sharing criteria.

Further, any unlicensed use or undeclared use under private arrangement with company not disclosed the DOI could/would constitute grounds to rescind the deal why extension of protections. This burden for example, falls clearly on Company D, as there is an unlicensed user creating “PRODUCT 3,” who may or may not have had private permission to use the technology; however now it is Company D's burden to report and pay on all profits and to indemnify misreporting from the unlicensed user, should they continue to make products related to patent Y. Products 1 and 2 and licenses 2, 3 and 4 are known by their respective beneficiaries, (companies C and D).

Herein, it is for example Company D's burden to confirm ongoing creation of products by and licensee, such as that of license 3, and collect the DOI mandated portion of revenue on behalf of that IP user. The DOI might have unique arrangements for licensees making products, to not impose scenarios that restrict or destroy the potential for such firms/entities to continue producing products relative to their previous licenses, now entering a period of potential extension under a DOI program, for example.

Thus, the DOI program creates very valuable transparency between technology and users, often cloaked by undeclared arrangements between companies owning patents and those using them. Should such transparency not be appealing to a company, DOI extended protections are, preferably, a voluntary option that can be foregone.

With reference to FIG. 2, a patent applicant provides information related to an invention, such as a patent application and/or other information, to a USPTO related system/database, by way of at least one, network such as the Internet. The DOI is given or has access to at least some information related to the patent application̂) without and/or without permission of the patent applicant, based on configuration of the innovation/system/method by the government entities managing and deciding such program parameters.

In one scenario, the USPTO conveys an application selected by the patent applicant for consideration/relaying to the DOI. The DOI, herein, reviews and determines interest in the innovation(s) and/or the innovator/inventor, at least. The DOI converts and/or prepares the information as a DOI file, which in this example is determined as an option of the DOI that the information combined with two other inventors' submissions (formerly patent applications as well,) would result in a collaborative work product result and/or inventing scenario creating a more valuable invention(s) and/or DOI licensable, multi-contributor “file”.

For example, an inventor of a “better bike” is unaware that a new invention for a “baby harness” for a bike and an improved “bike breaking system” are other inventions agreeably relayed onto the DOI in the past for their consideration. The “baby harness” is already a DOI file, from two years earlier, herein. The two other inventors' work is combined to form an improved bike with aspects contributed by the three inventors. In this example, the three are invited to the DOI campus, which is actual and/or virtual, and they collaborate on filing improvements to enhance the value and license-ability of their mutual “file.” Further, by way of this collaboration under the DOI, the inventor of the “better bike” is asked to become a DOI file manager, in the “human powered transport” innovation area of the DOI system. He thus becomes an organically discovered “expert” to review contributions, such as USPTO applications for consideration, toward identifying DOI interest and/or collaborative invention opportunities that may create ever more important/useful DOI “files”.

In FIG. 2 further, the combined application of the inventors becomes file 2 of the DOI, which is formalized as volume 2 in the DOI intellectual (“IP”) library of subscription based, protected innovations. In this case, the innovations(s) of volume 2 include related patent protection from the USPTO, as the DOI funded the identification, development and prosecution for patent(s) of key, mutually created aspects of the new baby carrying and safety braking bike. Thus, the inventors who, in this case, could not have afforded the potentially long and involved patenting process became co-authors in a file, with the DOI funding and facilitating proper patenting of DOI approved aspects of the mutual invention(s). Indeed, in this instance, the file manager and the three inventors, (how “authors” or “file contributors,”) were the determiners of the areas that were logical to patent. Of the three patent areas they proposed, the DOI approved two, seeing them as the most valuable possible innovation areas at that time for the DOI to invest and Sheppard through to protected IP. In yet another configuration, patent protection is not necessary and IP rights power is granted to DOI files with or without separate patent protection or USPTO involvement Though, herein the USPTO is preferred as a separate verifying and legitimizing vetting layer, (logically most of the prior art and patentability work being well resolved by DOI personnel and procedures, to reduce USPTO workload and burden).

FIG. 3 illustrates a distinct and important revenue generating aspect/method of the DOI innovation. With “inventions” being improved and at times combined toward more useful and/or revolutionary innovations, relative to US interests in part, a library with IP user subscriptions mandated, could earn enormously for the USA, funding innovation in areas of the innovations for example; well beyond the costs of running and improving the USPTO and DOI.

Herein, Company A is a billion dollar a year technology company. Their product A was improved by way of their DOI “subscription,” which in this instance costs $30 million per year. The value of that subscription is proven by the improvements to product A resulting from technology disclosed in files 1 and 3, developed by 12 inventors (“authors”) in total. In fact, as a subscriber in good standing, subscriber A gets to select up to 24 files to “license” in their subscription. A pays a premium, as an option, for the DOI to “notify” them of new innovations from DOI endeavors, either already existing as new files and/or patented inventions. Thus, the subscription services stimulate and improve Company A's viability, in essence providing R&D services and options that they would likely not have the resources to ever develop privately or under their own funding at Company A; even if they were relying on strategic partnership options.

Company B is an unlicensed user of at least on file of the DOI. Their better-breaking bike was created later than the submission of material by inventor(s) resulting in file 2. In fact, there are patents for the aspects of the bike, minus the child carrying aspects,) which product C by Company B is infringing potentially.

At an earlier date, Company B was mandated to subscribe to access “file 4” which taught important, patentable aspects of their product B. Their subscribing, under duress, resulted in a more expensive per-file subscription, relative to agreeable subscribers who did not choose to create products prior to subscribing and/or researching their endeavors relative to DOT protected (and USPTO) IP. Like the USPTO, or through the USPTO, the DOI in this example has the power to enjoin and/or affect the endeavors of companies, such as B, who do not properly acknowledge use of protected IP.

In total, herein is disclosed a program for adjusting nuances of the invention protection parameters of the nation, toward a logical sharing of revenue with the very powers that provide that invaluable legal protection of IP. Such funding may be allocated according to government decisions; logically the sharing of revenue in revenue from protected IP rights would be allocated to civic or other national endeavors in the industry areas to which the revenue generated relates. Revenue from extended drug patent protections, might go to fund drugs for the elderly, for example, or other “medical” programs that require tax based funding otherwise (for the same “dollar” spent that the DOI might provide.)

A “transportation” patent, such as one related to an automobile, might provide revenue under DOT extension that is allocated to the national road building and maintaining infrastructure, for example.

Distinct from that revenue sharing program, the present innovation further provides a system and method for identifying, facilitating and managing the flow of innovation and information between innovators/inventors and the end users of products and services related to their work. The DOT library of individual or multi inventor authored “files” would be a revolution in stimulating innovation, allowing for the agreeable identification, combination and nurturing of inventions that otherwise might not have become visible, due to inventor limitations for example. Further, the collaborative inventing forum(s) possible, between innovators under DOI rules and protections, would represent a safe, government protected venue for creating and enhancing innovations that would, in many cases, improve life for many citizens and improve the viability and productivity of US firms.

Naturally, the “authors” of such files as the DOI, would be encouraged with incentives, such as sharing of revenue in their “file(s)”. The value to each contributor might, in fact, be enhanced beyond their individual potential patent ownership options, prior to DOI involvement options. For example, the efforts of the DOT to create valuable and desirable files for firms, would attract “subscribers” to files involving the work of “authors,” who were former USPTO inventors. Further, the inventors' work is seen through to fruition under DOI funding and supervision, where for many inventors the work would never have been patented, due to limited resources and naivety about the patenting system; even if their innovations were entirely patentable and useful- and potentially valuable. The USPTO filings that go “public” due to abandonment alone, represents perhaps hundreds of billions in untapped innovation compensation revenue lost, when product makers access the teachings/inventions for free when an inventor abandons for reasons other than unpatentability of the material. Thus, sharing in a DOI “file” could be more intellectually and/or financially beneficial for a former “inventor” under the USPTO system.

Moreover, as the first government sponsored and protected collaborative inventing resource and library, the USA creates a world class and potentially unrivaled innovation breeder reactor from the an untapped natural resource, hereto restricted to proprietary isolation and unreasonable difficulty toward patenting and innovation fruition: THE MUTUAL CREATIVE POTENTIAL OF INDIVIDUALS GROUPED FOR THE PURPOSE OF COLLABORATIVE INVENTING.

These are only a few of the benefits related to the multi-level, multi-benefit programs, systems and methods of the present application.

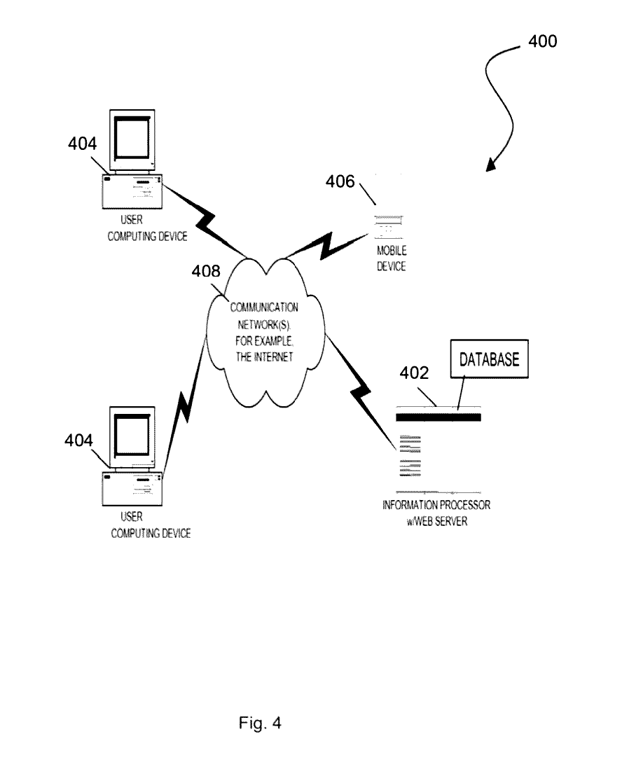

FIG. 4 is a block diagram illustrating a system 400 in accordance with an implementation of the present application. The system shown in FIG. 4 uses a bidirectional data communications network 402, such as the Internet, to establish a communication link that connects remotely located computing devices 404. The computing devices 404 may be configured to connect to send/receive various forms of data. The computing device 404 may utilize commonly used network programming platforms, databases 406 and protocols, such as shown and described herein. The computing device 404 may further connect to networks and databases using commonly understood programming interfaces and interface modules, e.g., Media Server Pro, Java, Mysql, Apache, Ruby on Rails, and other similar application programming interfaces and database management solutions. It will be appreciated that the system of implementations of the present application offers broad adaptability to user configurations, multiple user inputs, and hardware configurations. Moreover and as noted herein, the present application allows for a wide variety of remote devices 408 (portable computer, desktop, PDA, smart-phone, camera phone, web camera, or the like) to interface seamlessly notwithstanding different makes, models and settings of various containing devices.

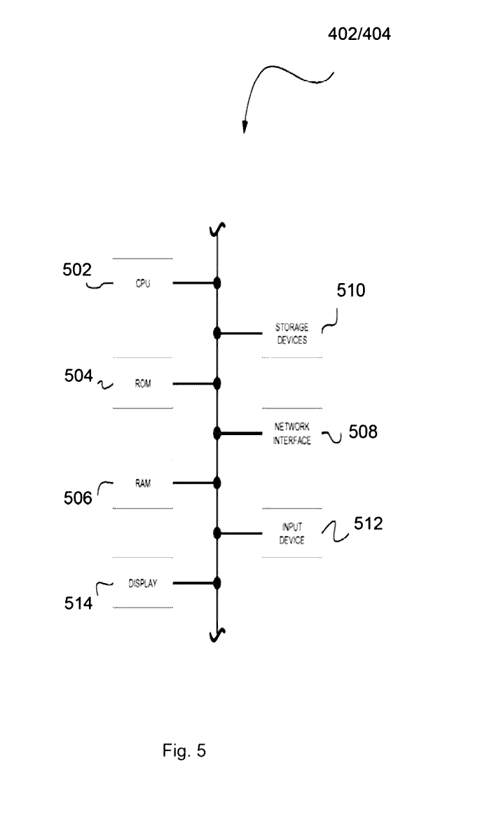

FIG. 5 illustrates components associated with a device 402/404, which may be a mobile computing device such as a portable computer, desktop, PDA, smartphone, camera phone, and web camera is configured for employing features described herein. The device may include a user interface, processor, memory and/or camera. The device may comprise one or more of any number of commercial devices or systems that are capable of capturing optical data through a lens and transmitting an image file that includes the captured data, such as a smartphone running the ANDROID operating system and which has a camera for capturing images. Although the device is represented herein as a single device, it is not limited to such, but instead can comprise a camera coupled to another system that enables image transfer over a network to the computing device of FIG. 4.

Continuing with reference to FIG. 5, a memory 502 is provided for storing data and instructions suitable for controlling the operation of the processor 504. Such memory may include, for example, a random access memory (RAM), a hard drive and a read only memory (ROM). One of the components stored in memory is a program. Program instructions may be provided for controlling the processor to execute steps associated with the present application. The program may be implemented as a single module or as a plurality of modules that operate in cooperation with one another. The program is contemplated as representing a software embodiment of the modules that implement the functionality and methodology described herein.

A user interface 506 may be provided that includes an input device, such as a keyboard, touch screen, tablet, or speech recognition subsystem, for enabling a user to communicate information and command selections to the processor. In the case of a touch screen, the input and output functions are provided by the same structure. Moreover, an output device such as a display or a printer may further be provided. A cursor control such as directional keys, a mouse, track-ball, or joy stick, can be employed to enable the user to manipulate a cursor on the display for communicating additional information and command selections to the processor, in embodiments in which the display is not a touch screen.

Program instructions may be configured on a storage media 508 for subsequent loading into one or more memories. The storage media may be any conventional storage media such as a magnetic tape, an optical storage media, a compact disc, or a floppy disc. Alternatively, the storage media may be a random access memory, or other type of electronic storage, located on a remote storage system.

Any or all of the exchanges of proprietary and other related data/information, may occur herein by way of a network linked system of computers. This exchange of information between databases, with DOI hub computing involved, powers the potential of automatic filtering and determination of many aspects, related to inventors/inventions and data in general, reducing the degree of human real time filtering and managing of information toward the mission of “most valuable resulting DOI files.”

Further, by empowering such an agency/entity, such as the DOI, the court system might enjoy a relaxing of the overburdened patent-enforcement dockets. With DOI subscriptions being powered, in part, by incentives and penalties valued by both innovators and product/service providers, many disputes may be resolved internally at DOI or by means other than patent litigation; typically motivated by individual, proprietary issues that are potentially reduced under DOI management and enforcement. This, not to replace the USPTO, but to support and augment its innovation stimulating, information sharing and progress promoting intentions.

Further, the unreasonable use of patents as “weapons” and as collateral used for profit by those not making products or even creating the patentable inventions, may be reduced by the present application and resulting DOI. An entire range of critical innovations owned mutually by the citizens of the US under the US government, might offset troubling issues. Such as, the modern day issue of resources being all too often scavenged and hoarded by firms with motive far from those originally disclosed when the USPTO was formed. Opportunities to exploit the dynamics of the US patent system and the powers given to private films, such as confidential LLC's in states such as Delaware and Nevada, may be offset at least in part by key US innovations residing in the volumes of the DOI library rather than in the hands of third parties not motivated by innovation or progress, but profit alone.

The DOI further provides the means for functioning as an agency, representing inventors and other creators of art, products, ideas and solutions.

The focus on the people and not the work product is key here. This is both an interactive, and in one configuration an entirely automated (or substantially) system and method. In another, the process might involve “agents” or “managers” as more nuanced intermediaries, managing interactions between creators and “monetizers” (product makers, licensees, investors, etc.,) that involve specific challenges not fully manageable by automated options and functions.

This agency, herein, will be referred to as “Collaborynt”.

Collaborynt brings, in part, methodology of Hollywood talent brokering in the creation of work product, to innovation and invention, and patent rights management.

In managing the talent associated with creating inventions, the actual source of the ideas and innovations is directly addressed. It is a human resource. Collaborynt, in the automated form, involves an interactive venue for safely transacting “options” related to “talent,” (such as inventors who are agreeably represented by Collaborynt).

In one configuration, talent has an interactive account with at least one Collaborynt database. As firms who “may” be current or future beneficiaries of protectable ideas from such talent, Collaborynt would provide a service for them to safely “option” or in a more marketable term, “sponsor” a selected inventor, (“artist” meaning inventor or other creative provider, hereafter). A firm being able to, under terms, access information related to the artist and selected work related to that artist, for example pending patent specification, might be given advantageous “early” options to sponsor the artist. Thus, accessing unique rights related to the artist and/or selected work of the artist.

For example, in finding innovation(s) already filed though not yet patented with the USPTO by the artist, (or by Collaborynt on behalf of the artist,) a product making firm, for example, might see benefit and or liability potential of the innovations relative to their future endeavors. By sponsoring the artist, for example with a $100,000 sponsorship (agreeably accepted by a selection provided previously and/or in reaction to the interest) such a firm (hereafter “sponsor”) might gain valuable innovation related information and/or limits on liability from their intended or unintended creation of revenue related to the work of the artist, (hereafter the “art”).

Typically, firms use innovations with little regard for the direct or indirect relationship of resulting products with inventions and/or patents that relate to the products; especially when the inventions were filed by “small entity” inventors. The likelihood of such inventors having the means to pursue larger firms for infringement or licensing fees effectively, is small. An industry has emerged of “trolls” or entities capable of pursuing infringers of such patents, though the inventor is disadvantaged typically financially and otherwise. The firms making products are likewise disadvantaged, paying retroactively for rights that relate to products, whether or not these firms feel their products/revenue were advantaged by the inventions as filed.

The system or invention protection was created to encourage the exchange of dialogue. Fear of suit and self-interest by the product makers have led to a system that uses IP to sequester and restrict innovation, and to cut off information between the original smaller innovators/inventors and the potential product providers, or actual monetizers of such inventions. The present application provides a safe passage of information, closer to the time of inception, between inventor and product provider/maker, by protecting the anonymity of the potential inventor sponsor until a “package” representing a transaction(s) agreeably receivable by the inventor for early rights, options and/or services is purchased/accepted.

Examples of such packages follow. Further, the “water temperature” of such packages may be selectable by the inventor (rights holder,) including in an interactive computer managed venue. Thus, parameters and even the option to participate in the venue may be limited by the venue dynamics and/or manager, but for inventors/artists properly participating, their threshold of willingness to receive “subscribers,” including how many and at what price(s) and/or how many, (and/or other variables,) may be variable. This would provide a scalable way for artists to receive early finding, in exchange for early work, rights and or rights options.

By providing a larger firm(s) herein with a lower cost alternative to later litigation settlements and judgments, with the critical bonus of early access to inspired ideas and work, driving earlier/better products, the invention protection system is directed back closer to its original mission and purpose.

Further, by demonstrating an interest from such firms and/or the public, in sponsoring artists, allowing people not work product to become the focus and value target of the present system and method, a paradigm shift occurs. By acknowledging the oil comes from the Earth, and not the delivered barrel, or in this case the inspired innovations come from human resources and not random work product results, an entirely new relationship between human inventiveness and the products and innovations it may inspire and drive is created.

Further, the present agency based venue and/or system, is geared to promoting and facilitating inventive/creative work to the marketplace without necessarily taking an ownership interest away from the creator to do so. As with the film and advertising industries, commissions related to the work/options agreeably procured under agreements limited at least by time, clarify who owns the work.

Further, if sponsorships include participation in an artist's performance, including revenue of certain work, this may be coordinated herein as an aspect of revenue sharing without artists necessarily signing over interest in their specific works as the only means to receive compensation from firms, which is a sad bi-product of the infringe first and accept liability if only forced to that has evolved to rule today.

Again, by creating early interest, privacy agreements and safe sharing of information and options, the ideas and their manifestation in the marketplace are brought into greater harmony and earlier synchronicity. Better, earlier versions of inventions may come to market, with transactions to the related people who were the inception of all or part of the products' aspects, having already occurred, at least in relation to firms advantaged by these people and ideas first and permissibly.

The present application is disclosed in relation to a computer managed venue that may perform all of the functions of an agency electronically. Another configuration may provide human involvement in decisions and/or interactions at one or more steps in the process, though the automated configuration allows for firms and/or the public to take interest in the artists. In one version, this is a system to reduce the likelihood of infringement by participating entities. It is also a system to reward agreeable exchange of funds and information before patent protection is assured, with a liability limiting device. It is also a system for expanding the research and development reach of a firm while simultaneously reducing patent infringement expenses from externally conceived inventions.

The present application is further described by way of the follow example and with reference to Table A:

TABLE A

| | | PRESET INVENTOR OPTIONS | |
|---|---|---|---|
| LEVEL: | up to 3 sponsors “A” size | level | first pat license cap |
| $100,000 | 500,000 per patent | 100,000 | 500,000 |
| | issued pat license option | 250,000 | 1,000,000 |
| | | 500,000 | 2,000,000 |
| | | (custom) | (custom) where feasibil |

Inventor time/work option: $25,000 month, 18 month minutes, up 20 claims. 10,000 per claim, additional $250,000 license, option per patent filing first option to purchase, and field exclusive. System variables may include sub-licensing options, terms relating to patent licenses, including product limitations, family or field of use buy out options, or first rights of refusal, including preferred sponsorship on second families relative to first-time sponsors' options, including extending licenses to partners on mutual products. In one or more implementations, inventions/patents are categorized using Collaborynt system and/or UPSTO classification. Alerts and solicitations may be transmitted to a user to enroll as a sponsoring member. Sponsors may access inventor materials, including inventor video pitches, and sponsors accessing pending materials are bound by non-disclosure agreements provided by and of the agency (infringers of private material assessed face treble damages). Further, sponsors may “accept” sponsorship options agreeably provided by inventors, typically at the pending patent(s) stage. Sponsors may involve inventors in their R&D or other efforts under agency rules and within inventor agreed packages/terms (use of name, credit, appearances, options, etc.). Sponsors enjoy the protection of privacy and identity protection from the inventors, as an agency guarantee, until sponsorship occurs or until infringement of material is determined. One sponsorship option for inventors is a full buyout of licenses to the inventor's work, permanently or for a period of filing date time, allowing for great value potential to the sponsor and inventor, early. Sponsors agree to privacy and/or enforcement terms of agency, if improper user of client art/work is determined. An agreeable “grievance” process may be involved, to further diminish fear of firms being “set up” for legal exposure, rather than relieved of legal liability for enrolling. Additional system variables may include sub licensing options terms relating to patent licenses, including product limitations family or field of use buy out options, or first rights of refusal preferred sponsorship on second families relative to first-time sponsors options, including extending licenses to partners on mutual products.

In one or more implementations, the present application provides talent (inventor) services. For example, sponsorship program revenue devices may be provided that are automated and manned. An alert may be transmitted of appropriate firms for suggested sponsorships, including existing and non-existing subscribers to the agency services. Sourcing of best subscriber options and agent input may be provided to financial and logistical terms. Further, inventor promotion to subscribers for potential licensees and time/services clients, and for press and public relations promotion and management, such as handling, appearances, etc. Further, branding of the inventor may be provided, such as to hire, publish, feature, license. Moreover, multi-inventor collaborations and creative services (think tank) to FIRMS may be provided, under various terms. Additionally, enforcement services including notification and referral to partner firms/legal for retroactive licensing efforts. Moreover, running royalty programs may be provided for easy enrollment and liability elimination by early sponsors. For example, a 2% of revenue early cap for sponsors, triple damages for private sponsor options alerted in pending stage who use the IP and Infringe. No privacy is provided to infringers, and in fact, subsequent reminders of the pending alerts to out at patent (such as worded to avoid declaratory judgment). Moreover, agency involvement and interest in recovered amounts in scenarios of infringement, allowing coordination of the legal efforts and financing to result in % to the agency, such as 20% of the inventor's portion.

The present application provides a venue for stimulating invention based progress, by brokering relationships between the people whose ideas can most advantage films marketing products related to those ideas.

Although illustrated embodiments of the present application have been shown and described, it should be understood that various changes, substitutions, and alterations can be made by one of ordinary skill in the art without departing from the scope of the present application.

1. A method, comprising:
categorizing, with at least one processor, intellectual property;
providing, with at least one processor, a solicitation to a plurality of registered members for sponsorship in at least some of the categorized intellectual property;
providing, with at least one processor and in response to a reply to the solicitation, materials associated with the at least some of the categorized intellectual property;
receiving, in response to the solicitation and/or the provided materials, a first acceptance to the sponsorship;
receiving, in response to the solicitation and/or the provided materials, a second acceptance to the sponsorship; and
providing, with the at least on processor, at least one license to make, sell and/or use the at least some of the classified intellectual property to at least one of the registered members at a maximum threshold value.

2. The method of claim 1, wherein the license includes terms associated with at least one selected from a group consisting of: product limitations; family; field of use; buy-out options; and rights of first refusal.

3. The method of claim 1, further comprising:
providing, with at least one processor, terms for confidentiality and/or non-disclosure prior to providing the materials associated with the at least some of the categorized intellectual property; and
receiving an acceptance of the terms prior to providing the materials associated with the at least some of the categorized intellectual property.

4. The method of claim 1, further comprising promoting, with at least one processor, at least one inventor respectively associated with the at least some of the categorized intellectual property.

5. The method of claim 1, further comprising providing, with at least one processor, options for sublicensing the at least some of the categorized intellectual property.

6. The method of claim 1, further comprising providing, with at least one processor, an offer for a full buyout of the at least some of the intellectual property, wherein the offer is for a temporary time period.

7. The method of claim 1, further comprising providing, with at least one processor, options contributing to research and development associated with at least one inventor associated with the at least some of the categorized intellectual property.

8. The method of claim 1, wherein the intellectual property includes domestic and/or foreign patents and patent applications.

9. A system, comprising:
one or more processors configured to interact with a non-transitory computer-readable medium in order to perform operations comprising:
categorizing, with at least one processor, intellectual property;
providing, with at least one processor, a solicitation to a plurality of registered members for sponsorship in at least some of the categorized intellectual property;
providing, with at least one processor and in response to a reply to the solicitation, materials associated with the at least some of the categorized intellectual property;
receiving, in response to the solicitation and/or the provided materials, a first acceptance to the sponsorship;
receiving, in response to the solicitation and/or the provided materials, a second acceptance to the sponsorship; and
providing, with the at least on processor, at least one license to make, sell and/or use the at least some of the categorized intellectual property at least one of the registered members at a maximum threshold value.

10. The system of claim 9, wherein the license includes terms associated with at least one selected from a group consisting of: product limitations; family; field of use; buy-out options; and rights of first refusal.

11. The system of claim 9, further configured to perform operations comprising:
providing, with at least one processor, terms for confidentiality and/or non-disclosure prior to providing the materials associated with the at least some of the categorized intellectual property; and
receiving an acceptance of the terms prior to providing the materials associated with the at least some of the categorized intellectual property.

12. The system of claim 9, further configured to perform operations comprising:
promoting, with at least one processor, at least one inventor respectively associated with the at least some of the categorized intellectual property.

13. The system of claim 9, further configured to perform operations comprising:
providing, with at least one processor, options for sublicensing the at least some of the categorized intellectual property.

14. The system of claim 9, further configured to perform operations comprising:
providing, with at least one processor, an offer for a full buyout of the at least some of the categorized intellectual property, wherein the offer is for a temporary time period.

15. The system of claim 9, further configured to perform operations comprising:
providing, with at least one processor, options contributing to research and development associated with at least one inventor associated with the at least some of the categorized intellectual property.

16. The system of claim 9, wherein the intellectual property includes domestic and/or foreign patents and patent applications.
